(19) United States
(12) Patent Application Publication
(10) Pub. No.: US 2026/0245395 A1
(43) Pub. Date: Aug. 20, 2026

(54) AI PROCESSING OF ARCHITECTURAL DRAWINGS

(71) Applicants: Jeffrey W. Twardzik, Mohawk, MI (US); Gergana Marinova Gospodinova, Alexandria, VA (US); Amirtharaj Karuppaiah, Suwanee, GA (US); Greg Cory, Dallas, GA (US)

(72) Inventors: Jeffrey W. Twardzik, Mohawk, MI (US); Gergana Marinova Gospodinova, Alexandria, VA (US); Amirtharaj Karuppaiah, Suwanee, GA (US); Greg Cory, Dallas, GA (US)

(21) Appl. No.: 19/642,482

(22) Filed: Apr. 8, 2026

Related U.S. Application Data
(63) Continuation of application No. 19/294,644, filed on Aug. 8, 2025, now abandoned.
(60) Provisional application No. 63/732,383, filed on Aug. 8, 2024.
(60) Provisional application No. 63/859,837, filed on Aug. 7, 2025.

(51) Int. Cl. G06V 30/422; G06F 16/55; G06T 3/02; G06T 7/11; G06T 7/33; G06V 30/148; G06V 30/19; G06V 30/414

(52) U.S. Cl. CPC G06V 30/422; G06F 16/55; G06T 3/02; G06T 7/11; G06T 7/33; G06V 30/153; G06V 30/191; G06V 30/414; G06T 2207/20081; G06V 2201/10

(57) ABSTRACT

A computing system and application for the AI processing of architectural drawings. The system comprises a centralized information repository, interactive building plans, and knowledge sharing mechanisms. The application comprises a layout segmentation component that detects all rooms within a given drawing along with their corresponding labels. It also comprises a drawing alignment component that aligns drawings using three shared reference points. The application also includes a metadata extraction component to retrieve metadata from architectural drawings, including sheet number, sheet title, date, last revision date, sheet type, sheet discipline, and floor number. The system creates a searchable architectural drawing database.

### CROSS REFERENCE TO RELATED APPLICATIONS

This Continuing Non-Provisional Patent Application claims priority to U.S. Non-Provisional patent application Ser. No. 19/294,644 filed Aug. 8, 2025 which claims benefit of Provisional Patent Application No. 63/859,837 filed Aug. 7, 2025 and Provisional Patent Application No. 63/732,383 filed Aug. 8, 2024, the entire disclosures of which are hereby incorporated by reference and relied upon.

### BACKGROUND OF THE INVENTION

### Field of the Invention

The invention relates generally to architectural drawings, and more particularly to searchable collections of architectural drawing sets.

### Description of Related Art

Many companies and research efforts utilize very simple architectural drawings as a means to manage the large volume of information that could be included on the drawings. However, these simple architectural drawings do not reflect the complexity and variability of real-world architectural plans used in the industry. These simplified drawings often fail to include the intricate details and diverse elements present in architectural drawings and are therefore limited in their effectiveness and applicability.

There are significant inefficiencies in current approaches to architectural drawings. This leads to a substantial amount of time spent searching for information related to the equipment and systems by those who are responsible for maintaining the buildings and equipment. In the Applicant's experience, it is common for one-third of a team's time to be consumed by locating manuals, safety information, maintenance histories, searching for plans and the information within them, and other critical documentation. This inefficiency stems from the three key challenges listed below.
1. Disparate Information Sources: Information is often scattered across multiple platforms and physical locations, including manuals, plans, paper documents, digital files on different systems, and personal notes maintained by individual team members. This fragmentation leads to delays in accessing necessary data and increases the likelihood of errors and oversight.
2. Complexity of Facility Operations: Facilities encompass a wide variety of equipment and systems, from HVAC and electrical to specialized devices. Each piece of equipment requires specific knowledge for proper maintenance and operation, making it difficult for new team members to become proficient quickly.
3. Institutional Knowledge Transfer: Experienced workers possess a wealth of knowledge gained through years of hands-on experience. However, this knowledge is often not documented or is inadequately shared with newer employees. This gap in knowledge transfer can lead to operational disruptions and a steep learning curve for incoming personnel.

To address these issues, what is needed is an integrated system that enhances access to information, facilitates interaction with building plans, and promotes the transfer of institutional knowledge.

Such a system would not only streamline the workflow of facilities teams but also ensure that critical information is preserved and easily transferred to new employees. This, in turn, would enhance the overall efficiency and reliability of facility operations.

### SUMMARY OF THE INVENTION

Disclosed herein is a computing system with computer application that integrates advanced machine learning models and combines multiple essential computing tasks into a single application to ensure a seamless, accurate, and efficient process for creating a searchable collection of architectural drawings.

In one form, the application comprises a centralized information repository (CIR). The CIR is a single, easily accessible digital platform that consolidates all relevant documentation, including equipment manuals, maintenance logs, and building plans. The CIR is searchable and organized in a manner that allows quick retrieval of information.

In one form, the application comprises interactive building plans (IBP). IBP are digital plans of a facility that allow users to pin assets (e.g., equipment, infrastructure elements) and define coverage areas. The IBP is easily searchable and available in the field where the teams need it. This interactivity would enable facilities teams to visualize and manage their facilities more effectively, ensuring that all assets are accounted for and properly maintained.

In one form, the application comprises knowledge sharing mechanisms (KSM) which are tools and processes that facilitate the documentation and sharing of institutional knowledge. This could include features for annotating equipment details with practical tips, recording maintenance procedures, and creating video tutorials that demonstrate common tasks.

In one form, the application comprises advanced machine learning models and combines multiple essential tasks within the application. This combination ensures a seamless, accurate, and efficient process for creating a searchable collection of all architectural drawings, tailored to the complexities of real-world industry standards.

In one form, the application unifies layout segmentation, region segmentation, room number extraction, drawing alignment, and metadata extraction into one application. This unification streamlines the entire process of utilizing architectural drawings thereby reducing the need for multiple tools and improving overall efficiency and accuracy when seeking information from the drawings.

In one form, the application focuses on using various methods and models to automate the processing of architectural drawings.

In one form, the application recognizes and interprets various data contained on architectural drawings. This is typically a difficult task that stems from the absence of a standardized layout for drawings, as architects tend to structure them according to their individual preferences. For example, certain common elements, like title, sheet number, date, and location, are typically located in the right corner of a drawing, they can at times appear at the bottom. Additionally, drawings often incorporate various other elements such as tables, diagrams, and enlargements of specific components. The process of creating various models and algorithms to enhance drawing navigation and searchability requires extensive learning and adaptation, especially considering the diversity of drawings present, some of which date back to the 1960s.

In one form, the application actively creates innovative methods and solutions to revitalize drawings with included technical information and data to ensure accessibility and knowledge for everyone, including those without specialized training to interpret them.

In one form, the application will perform the following tasks. Layout Segmentation, which is the detection of all rooms within a given drawing along with their corresponding labels. Drawing Alignment which is aligning drawings using three shared reference points, and Metadata Extraction which is the retrieval of metadata from architectural drawings, including sheet number, sheet title, date, last revision date, sheet type, sheet discipline, and floor number.

In one form, the application performs Layout Segmentation which comprises three sequential steps: initially locating the layout outline, executing the segmentation model, and identifying the room numbers.

In one form, the application performs Layout Outline during which room boundaries are typically depicted as shapes, often rectangles, with the room number text centered within. The application focuses on extracting these boundaries by effectively filtering out other components.

In one form, the application avoids mis-identification of other parts of the drawing which involves training a model using drawings that contain a floor plan. The Segment Anything Model (SAM) can be used as the foundation to this solution. SAM is a promptable segmentation system designed to generalize unfamiliar objects and images without requiring additional training.

In one form, SAM is been trained on various image types and primarily consists of vivid images from daily life, encompassing diverse objects.

In one form, a prompt is required to guide the model's segmentation process which can take the form of foreground/background points, a rough box or mask, free-form text, or any other relevant information indicating what to segment in the image.

In one form, a method of fine-tuning the SAM model uses manually labeled plan outlines and providing a prompt with coordinates (0,0,x_max, y_max).

In one form, a post-processing step is required to identify a bounding box comprising four points. This post-processing involves utilizing two mathematical algorithms from scikit-image (also known as skimage). The regionprops function is then applied to measure properties of labeled image regions, with a focus on identifying the bounding box (min_row, min_col, max_row, max_col).

In one form, the bounding box is resized to encompass the entire image rather than just the specified region, completing the segmentation outline identification process.

In one form, once the floor plan outline is identified, a region segmentation process is executed, which involves employing two distinct approaches and amalgamating their outputs. The primary approach utilizes a model developed in-house, while the secondary approach relies on a mathematical algorithm.

In one form, the model along with the fine-tuned Sam model are trained on a dataset labeled using the LabelMe tool.

In one form, the CubiCasa5k dataset is used.

In one form, data preparation for model training involves using the label JSON output and the corresponding drawings. These are combined into new images, with original images plotted on one half and labeled room outlines on the other.

In one form, a pix2pix model is employed and a conditional generative adversarial network (cGAN) that learns a mapping from input images to output images.

In one form, a process for a mathematical algorithm that detects connected components is utilized. Beginning with a black-and-white image, operations such as erosion, dilation, and blurring are used before using a find contours function to retrieve contours.

In one form, two methods are utilized because trained models excel with complex plans, while the mathematical approach performs better with simpler ones. Combining them yields optimal results.

In one form, following region extraction, a rule-based algorithm is employed to determine correct regions, including removing small regions within larger ones, eliminating invalid polygons, and resolving intersecting polygons.

In one form, once the regions are identified, the room number/label task function is executed using Optical Character Recognition (OCR) service to extract all text from an image.

In one form, the extracted text is segmented into different entities, including words, lines, and paragraphs.

In one form, a process is executed to associate each paragraph with an identified region.

In one form, a drawing alignment process comprises the steps of identifying plans, running layout extraction, finding common points, and performing affine transformation.

In one form, AI processing of architectural drawings application comprises extracting metadata from drawings.

In one form, extracting metadata from drawings comprises the step of using OCR.

In one form, extracting metadata from drawings comprises the step of identifying metadata categories.

In one form, extracting metadata from drawings comprises the step of integrating with language models.

In one form, extracting metadata from drawings comprises a process for merging the outputs from both the rule-based approach and the LLM analysis to achieve high accuracy and creating a comprehensive and searchable inventory of architectural drawings.

### BRIEF DESCRIPTION OF THE SEVERAL VIEWS OF THE DRAWINGS

These and other features and advantages of the present invention will become more readily appreciated when considered in connection with the following detailed description and appended drawings, wherein each drawing is according to one or more embodiments shown and described herein, and wherein:

FIG. 1 depicts a plan view of an architectural drawing showing an example of SAM model input and output;

FIG. 2 depicts a plan view of an architectural drawing showing an example of layout segmentation input and output;

FIG. 3 depicts an example of a plan view of an architectural drawing with text extracted;

FIG. 4 is a graphic depicting affine transformation;

FIG. 5A depicts an example of two individual architectural floor plan drawings of a space;

FIG. 5B depicts a graphic showing a drawing overlay output based on the 2 stacked architectural drawing inputs depicted in FIG. 5A;

FIG. 6 depicts a graphic showing 3 main components of an AI processing architectural system;

FIG. 7 depicts a graphic showing components of an AI processing architectural drawings application;

FIG. 8 depicts a graphic showing process steps involved in a layout outline process of the layout segmentation process;

FIG. 9 depicts a graphic showing process steps involved a region segmentation process of the layout segmentation process;

FIG. 10 depicts a graphic showing process steps involved in a room number extraction process of the layout segmentation process;

FIG. 11 depicts a graphic showing process steps involved in a drawing alignment process;

FIG. 12 depicts a graphic showing process steps involved in a metadata extraction process;

FIG. 13 is a graphic depicting various computing components which can be utilized in an AI processing architectural system;

FIG. 14 is a graphic depicting some of the many various forms of computing device that can be utilized in an AI processing architectural system.

### DETAILED DESCRIPTION OF SELECTED EMBODIMENTS OF THE INVENTION

Select embodiments of the invention will now be described with reference to the Figures. Like numerals indicate like or corresponding elements throughout the several views. The terminology used in the description presented herein is not intended to be interpreted in any limited or restrictive way, simply because it is being utilized in conjunction with detailed description of certain specific embodiments of the invention. Furthermore, embodiments of the invention may include several novel features, no single one of which is solely responsible for its desirable attributes or which is essential to practicing the invention described herein.

Disclosed herein is a computing system with computer application that integrates advanced machine learning models and combines multiple essential computing tasks into a single application to ensure a seamless, accurate, and efficient process for creating a searchable collection of architectural drawings.

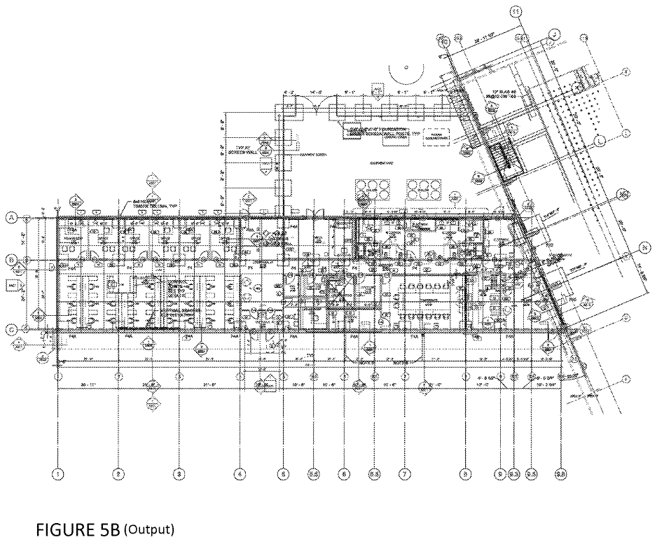

The computing system comprises a variety standard computing components on which an AI processing architectural system (200) (AIPAS) is based (FIG. 6). The AIPAS comprises a centralized information repository (CIR) (202) which is a single, easily accessible digital platform that consolidates all relevant documentation, including equipment manuals, maintenance logs, and building plans for one or more buildings. The CIR is searchable and organized in a manner that allows quick retrieval of information.

AIPAS (200) comprises interactive building plans (IBP) (204). IBP are digital plans of a facility that allow users to pin assets (e.g., equipment, infrastructure elements) and define coverage areas.

The AIPAS comprises knowledge sharing mechanisms (206) (KSM) which are tools and processes that facilitate the documentation and sharing of institutional knowledge. The application unifies layout segmentation, region segmentation, room number extraction, drawing alignment, and metadata extraction into one application.

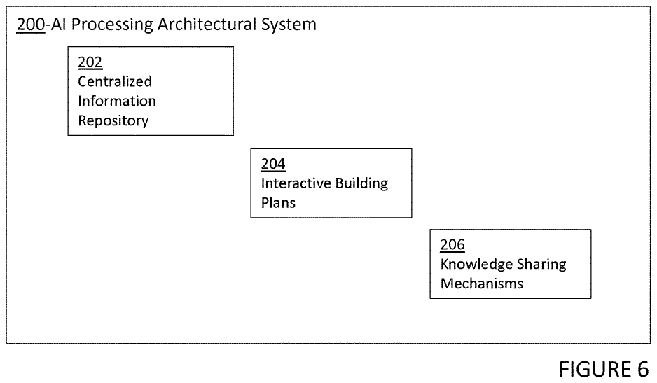

As depicted in FIG. 7, the application will perform three primary functions. The first is layout segmentation (301), which is the detection of all rooms within a given architectural drawing along with their corresponding labels. The second is a drawing alignment process (303) which aligns drawings using three shared reference points, and the third is metadata extraction which is the retrieval of metadata from stored architectural drawings, including sheet number, sheet title, date, last revision date, sheet type, sheet discipline, and floor number.

Further to FIG. 7, the layout segmentation (301) function comprises three sequential steps: initially locating the layout outline (306), executing the region segmentation process (340), and identifying the room numbers in an identified region process(370).

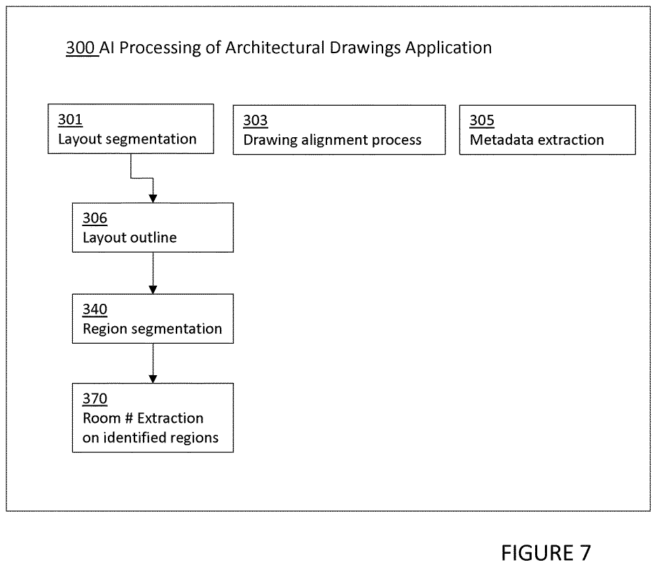

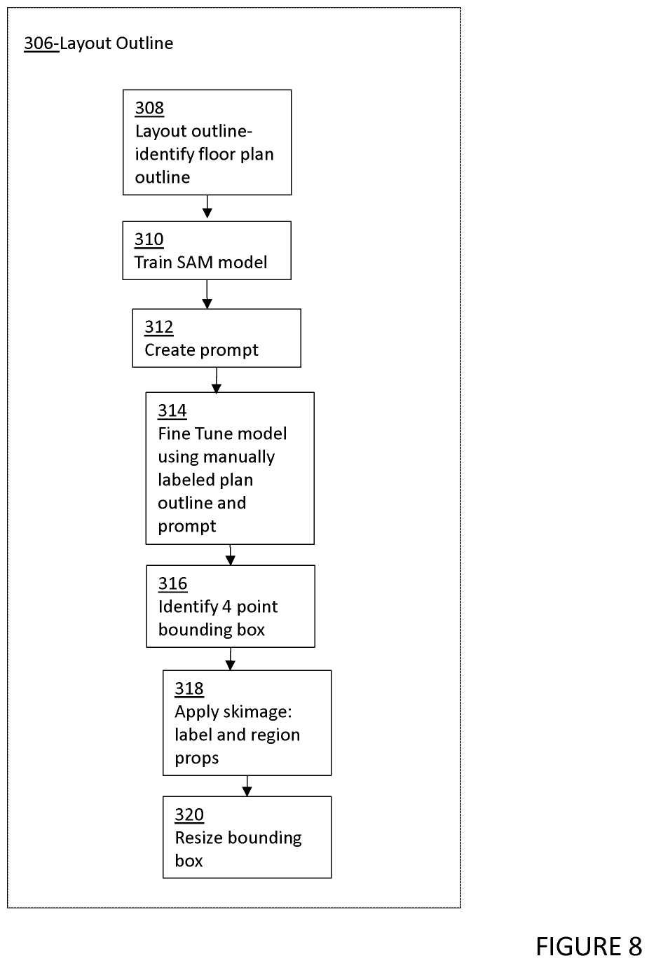

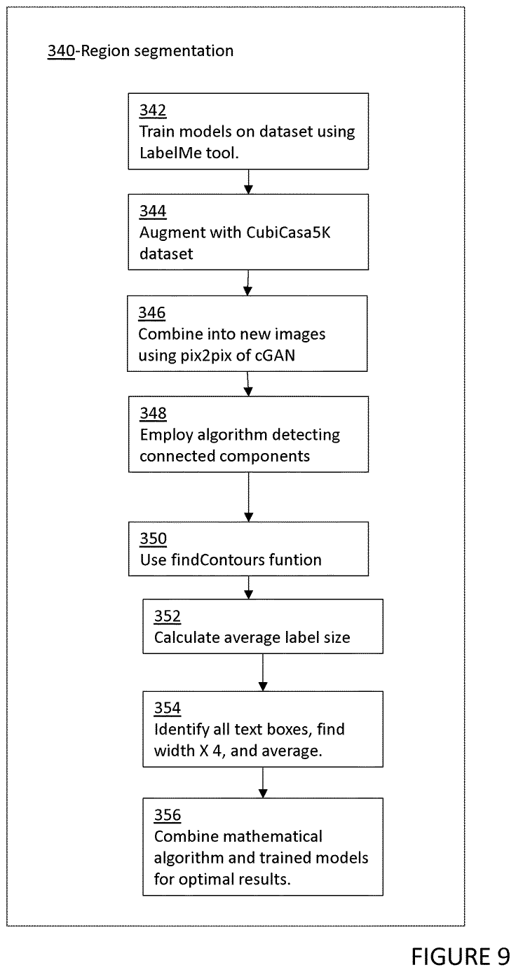

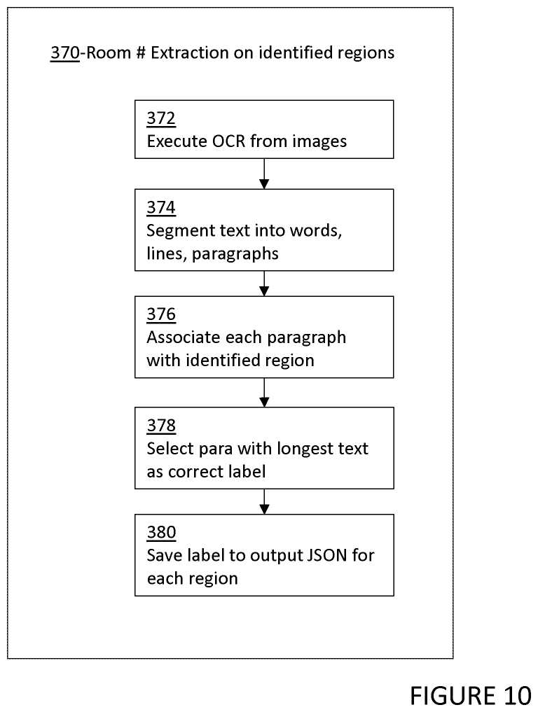

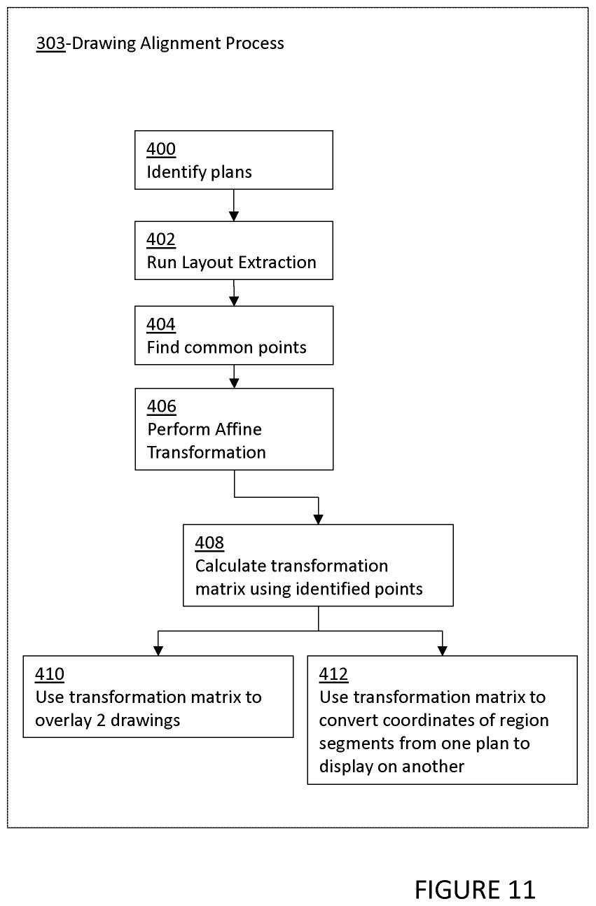

FIG. 8 depicts steps that take place within the layout outline (306) process during which room boundaries are typically depicted as shapes, often rectangles, with the room number text centered within. The application focuses on extracting these boundaries and identifying the floor plan outlines by effectively filtering out other components. For example, a common layout convention involves framing the drawing, with metadata presented in a table-like format on the right side. The floor plan, if included, is usually centered, with a legend positioned in the bottom right corner beneath it. In preferred embodiments, layout segmentation involves the step of initially identifying the floor plan outline (308) thereby avoiding the misidentification of other parts of the drawing like tables or metadata as rooms due to their similar shapes.

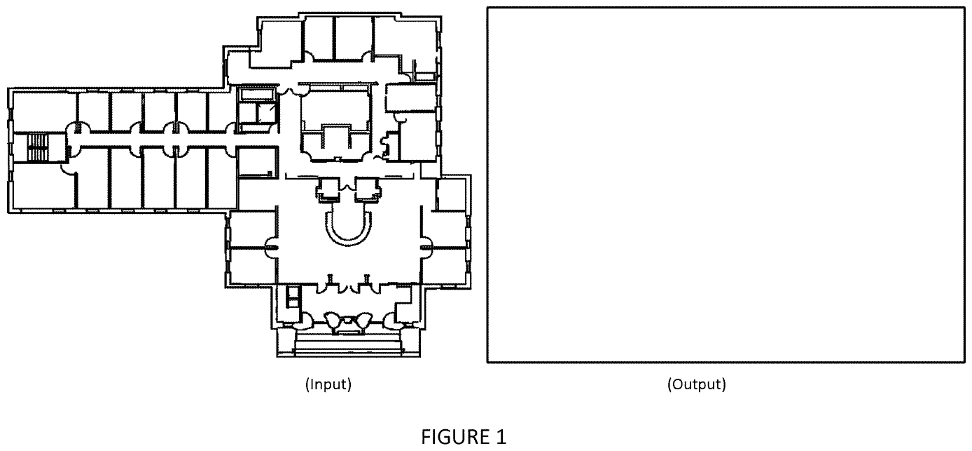

The application avoids mis-identification of other parts of the drawing by training a model using drawings that contain a floor plan. A Segment Anything Model (SAM) is used as the foundation to this solution. FIG. 1 is an example of SAM model input and output. In a train SAM model step (310), SAM is used as a promptable segmentation system designed to generalize unfamiliar objects and images without requiring additional training. SAM has typically been trained on various image types and primarily consists of vivid images from daily life, encompassing diverse objects.

The next step in the layout outline (306) process, a prompt is created (312) and used to guide the model's segmentation process which can take the form of foreground/background points, a rough box or mask, free-form text, or any other relevant information indicating elements to segment in the image. Typically the floor plan resides in the center of the image but this is not always the case. Therefore determining the appropriate input for the model can pose a challenge.

Once the prompt is created, the SAM model is finetuned (314) using manually labeled plan outlines and providing a prompt with coordinates (0, 0, x_max, y_max). These coordinates instruct the model to focus on identifying structures resembling an entire floor plan when prompted with the coordinates of the entire image. The model's output covers the area it identifies as the floor plan location, which may not represent a geometrically precise shape.

Next, a post-processing step is required to identify a bounding box comprising four Points (316). This post-processing involves processing utilizing two mathematical algorithms from scikit-image (also known as skimage (318)) which is a Python package that provides a collection of algorithms for image processing. The label property when used with the regionprops, refers to the unique identifier assigned to each segmented region within an image. The regionprops function then uses these labels to calculate various properties for each distinct region. The label function labels connected regions of an integer array, using pixels as neighbors if they have the same value and are connected in either a 1-or 2-connected sense. The regionprops function is then applied to measure properties of labeled image regions, with a focus on identifying the bounding box (min_row, min_col, max_row, max_col).

Finally, a process is executed to resize the bounding box (320) to encompass the entire image rather than just the specified region, completing the segmentation layout outline (306) identification process.

### Region Segmentation

Once the floor plan outline is identified in the layout outline (306) step, a region segmentation process (340) is executed. This involves employing two distinct approaches and amalgamating their outputs. The primary approach utilizes a model developed in-house, while the secondary approach relies on a mathematical algorithm.

In the initial step of region segmentation, along with the fine-tuned Sam model from step (310), the models are trained on a dataset labeled using the LabelMe tool (342). The tool is designed for efficient image annotation. However, due to the labor intensive nature of labeling, a typical dataset is limited to approximately 200 files. To augment this, a CubiCasa5k dataset is utilized (344), comprising 5000 labeled floor plan images. Despite its simplistic representations compared to the typical client submissions, incorporating this supplemental dataset significantly enhances the model's performance.

Data preparation for model training involves using the label JSON output and the corresponding drawings. These are combined into new images, with original images plotted on one half and labeled room outlines on the other. This is done by employing a pix2pix model (346), a conditional generative adversarial network (cGAN) that learns a mapping from input images to output images. This type of model is suitable in many cases because at its core, it is not application-specific; it can be applied to a wide range of tasks, including synthesizing photos from label maps, generating colorized photos from black and white images, converting Google Maps photos into aerial images, and even transforming sketches into photos.

Additionally, a mathematical algorithm is executed that detects connected components (348). Beginning with a black-and-white image, we perform operations such as erosion, dilation, and blurring before using the find Contours function (350) to retrieve contours. The function retrieves contours from the binary image using a computer vision algorithm. By defining the minimum contour area based on the average label size and converting polygons to convex shapes where applicable. The average label size is then calculated during the label extraction process (352). It is defined as the average size of all four-letter words, as our research indicates that the smallest possible room is typically not smaller than that. The process includes identifying all text boxes, processing each one to find the width of a single character, multiplying that by four, and then averaging the results (354).

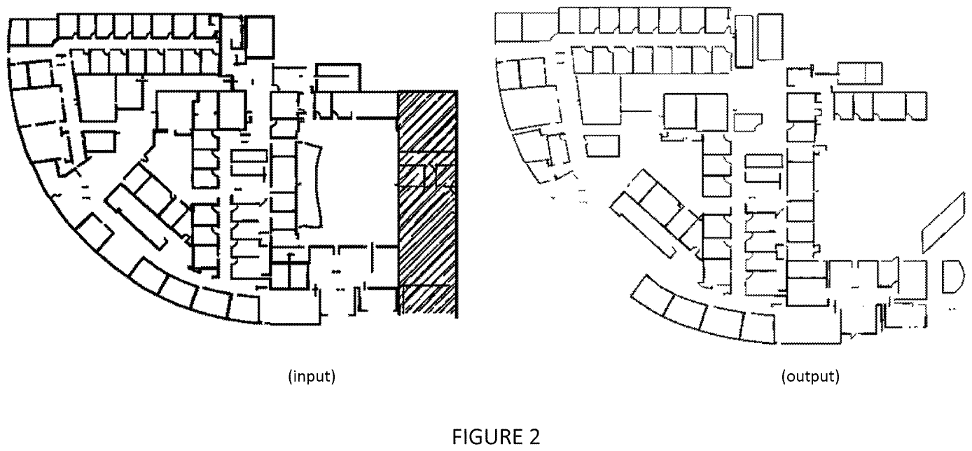

Both methods are utilized as testing revealed that trained models excel with complex plans, while the mathematical approach performs better with simpler ones. Combining the two models yields optimal results (356). Following region extraction, a rule-based algorithm is employed to determine correct regions, including removing small regions within larger ones, eliminating invalid polygons, and resolving intersecting polygons. This comprehensive process prepares us for the subsequent steps. FIG. 2 depicts an example of layout segmentation input and output.

### Room Number Extraction

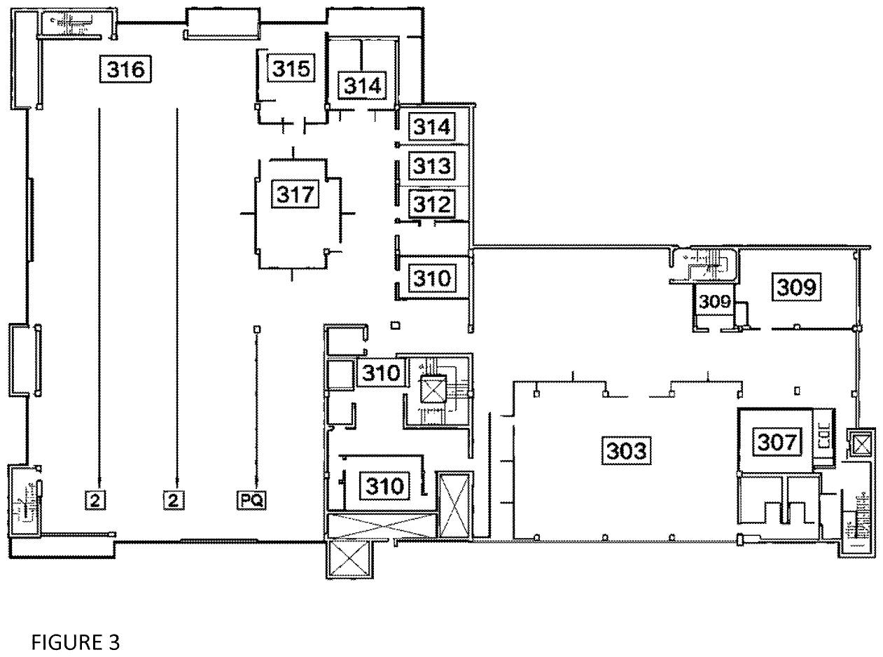

Once the regions are identified by the region segmentation process (340), a room number/label extraction on identified regions process (370) is executed. An optical character recognition (OCR) service (372) such as AWS Textract or Google Vision is utilized which extracts all text from the image. FIG. 3 depicts results of such a service applied to a sample floor plan. The extracted text is then segmented into different entities, including words, lines, and paragraphs (374). When addressing room numbers, it's optimal to utilize paragraphs, as room names/numbers often span across multiple lines and are formatted in a way that aligns with the center of the region. Upon identifying paragraphs, the next step is to associate each paragraph with an identified region (376). This is achieved by examining each region and determining which paragraphs fall within it, and selecting the paragraph with the longest text (378) as the correct label. The corresponding label is then saved to the output JSON for each region (380). FIG. 2 illustrates the JSON output for a given plan. However, this approach has limitations, particularly in cases where the label lies outside the region or is indicated by an arrow pointing to the region. While such occurrences are infrequent, they do exist, especially for smaller regions where the label cannot fit within the area. FIG. 3 depicts an example of label extraction output.

### Drawing Alignment

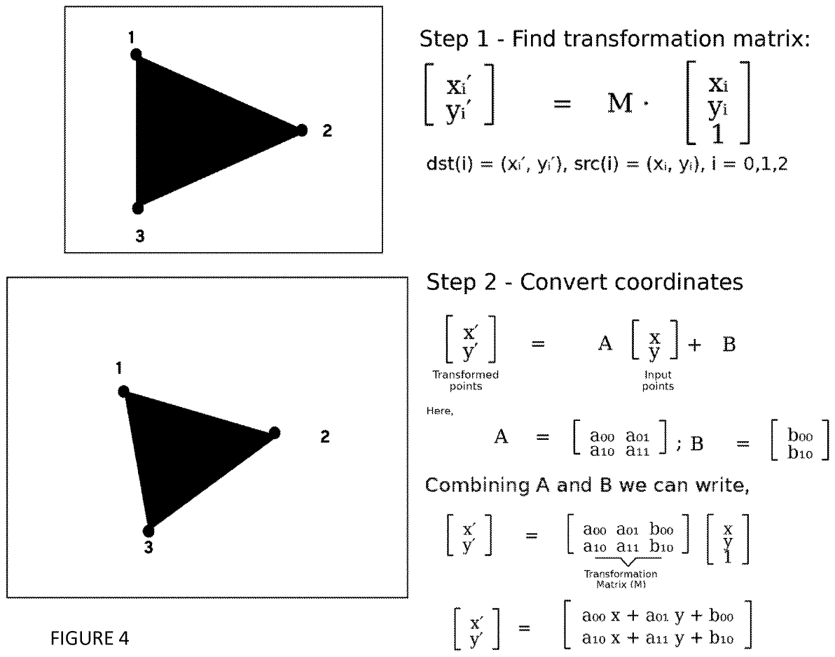

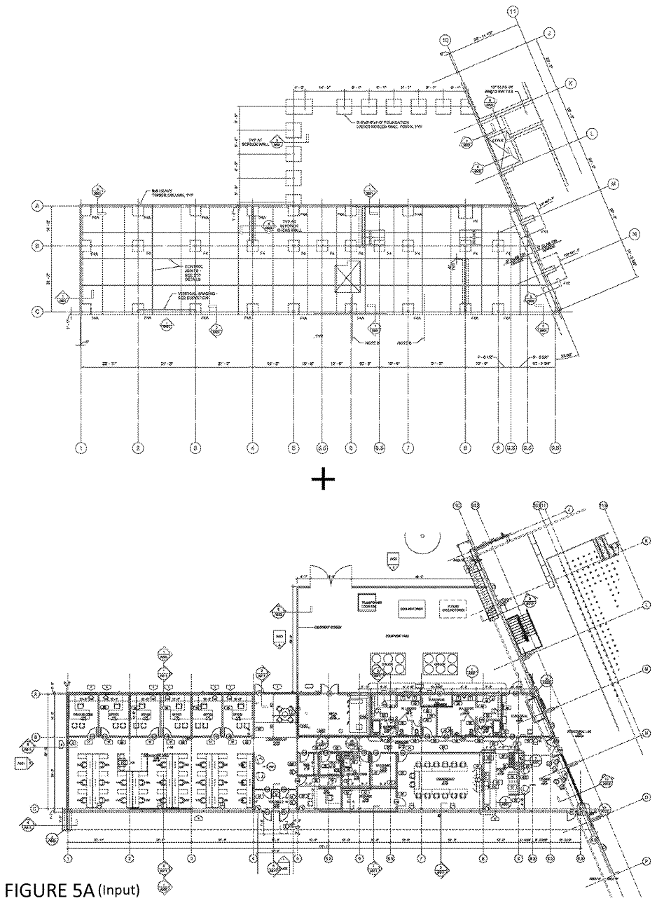

The layout segmentation process is only possible for drawings that include a floor plan with distinctive room boundaries. Typically, this includes sheets in the architectural or structural disciplines. Most other disciplines that feature floor plans do not include room boundaries. The absence of room boundaries can make it difficult to identify the exact location of certain equipment on the floor plan. To solve this problem, the following steps are executed. The first step is to identify plans (400). Here, a process is run that finds plans that show the same floor for different disciplines. The next step is to run layout extraction (402). In this step, the layout extraction pipeline is executed on one of the eligible plans. Next, a process to find common points is run (404). In this process, three common points on each plan are identified. This is followed by a process that performs affine transformation (406). An affine transformation, as depicted in FIG. 4, can be expressed as a matrix multiplication (linear transformation) followed by a vector addition (translation). This ensures that all parallel lines in the original image remain parallel in the output image. An Example of this is illustrated in FIG. 4. Steps in the process of performing an affine transformation are as follows. Running a process to calculate the transformation matrix using the identified points (408). Running a process using the transformation matrix to overlay two drawings (410) or running a process to convert the coordinates of region segments detected in one plan and display them on another plan (412). An example of a drawing overlay using this method is depicted in FIG. 5A and FIG. 5B wherein FIG. 5A depicts 2 individual input drawings that are overlayed to create the output drawing depicted in FIG. 5B.

### Metadata Extraction

Architectural drawings often contain essential metadata, such as sheet names and numbers, which are crucial for creating a searchable inventory of all drawings for a particular building. Two approaches are utilized to effectively extract this metadata. To achieve this, the pipeline goes through the following steps.

To initiate the metadata extraction process (305), a process is run for text to be extracted from the drawings using Optical Character Recognition (OCR) (450). Given that metadata is typically located on the right side of the image, the drawing gets cropped to cover the area (0.8*max_x, 0, max_x, max_y). This focused area is then processed to extract only the relevant text. In the next process, metadata categories are identified and the following categories of metadata are extracted using key words. These include: sheet number, sheet title, date, last revision date, sheet type, sheet discipline, and floor number. The text extraction is followed by identifying potential titles for these metadata categories using predefined keywords for each category (452).
Sheet Number: Identified using regular expressions that match common patterns, such as a letter followed by a number, and variations thereof.
Sheet Title: Keywords commonly found in sheet titles are used to identify these, often spanning multiple lines.
Dates: A list of possible dates is generated by matching patterns like MM-DD-YY or DD/MM/YYYY. The most recent date or the closest date to the “date” label is selected.
Revision Date: The latest revision date is identified from a list of revisions.
Sheet Type: Keywords corresponding to types like detail, section, and plan are searched within the sheet title. It is important to note that each drawing could have more than one sheet type.
Sheet Discipline: Identified by the initial letter(s) of the sheet number, for example, ‘A’ in A101 stands for architectural.
Floor Number: Extracted from the sheet title if words like “floor” or “level” are followed or preceded by numbers, either a single number or a range of numbers.

The next process step is integration of the results with language models (454). After extracting and preliminarily categorizing the text, the results are integrated with a Large Language Model (LLM) (458) to enhance accuracy. The LLM processes the combined text from the OCR output (456), identifying metadata such as sheet number, sheet title, date, and revision date without being constrained by the predefined patterns.

The final step in metadata extraction is results integration in which a process merges the outputs from both the rule-based approach and the LLM analysis (460) to achieve high accuracy. This combined method ensures that metadata is accurately extracted and categorized, creating a comprehensive and searchable architectural drawing database (462).

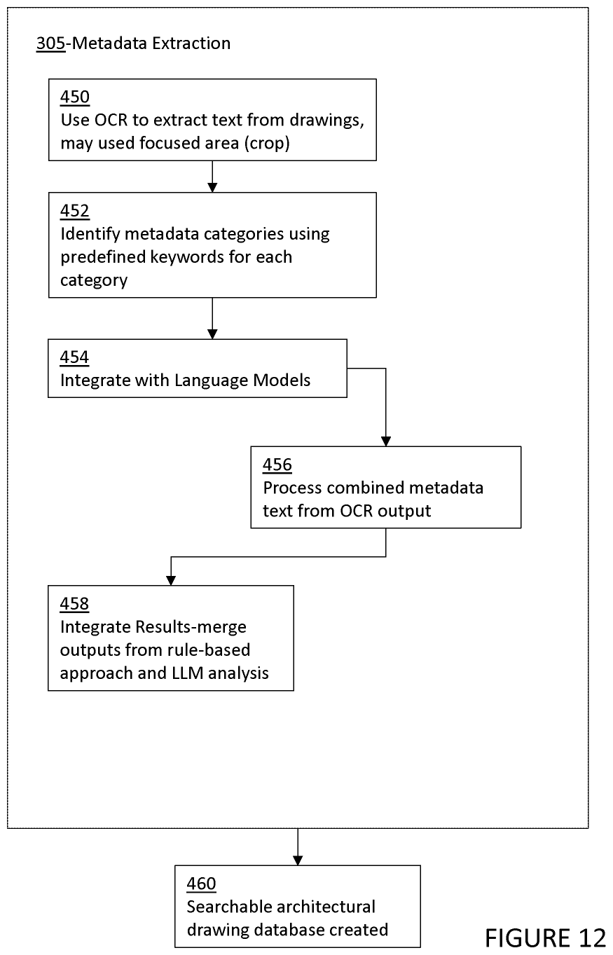

As illustrated by example and not limitation in FIG. 13, computer architecture supporting an AIPAS 200 can include one or more processor(s) 120, one or more memory device(s) 122, one or more network interface(s) 130 to interface with a network 132, one or more local storage 128 or remote mass storage device(s), one or more of Input/Output (I/O) device(s) such as a mouse 118 and keyboard input device 116 and voice recognition 114 and video and touch device 112, and one or more display 135, all of which are coupled to a bus 134. The displays are utilized to display user and when necessary, administrator facing options such as for example, those related to layout segmentation, drawing alignment, and metadata extraction. These user and administrator options are selectable by the user and administrators through use of the I/O devices. Processor(s) 120 include one or more processors and controllers that execute instructions from the AIPAS 200 stored in memory device(s) 122 and mass storage device(s) (i.e. local storage 128). Processor(s) may also include various types of computer-readable media, such as cache memory.

Memory device(s) utilized in the computing systems described herein may include one or more various computer-readable media, such as volatile memory (e.g., random access memory (RAM)) and nonvolatile memory (e.g., read-only memory (ROM)). Memory device(s) may also include rewritable ROM, such as flash memory. A memory device may also be in the form of mass storage device(s) including various computer readable media, such as magnetic tapes, magnetic disks, optical disks, solid-state memory (e.g., flash memory), and so forth. Mass storage devices may be in the form of a hard disk drive to serve various computing devices. Various drives may also be included in mass storage device(s) to enable reading from and/or writing to the various computer readable media. Mass storage device(s) may include removable media and/or non-removable media.

Memory may be used for storing an operating system 126, application programs such as web browsers 124, other program modules, and program data such as data related to the AIPAS app 200 disclosed herein. The apps described herein can operate according to the resident operating system. I/O device(s) include one or more of various devices that allow data and other information to be input to and retrieved from computing device(s). Example I/O device(s) include one or more of; cursor control devices, keyboards, keypads, microphones, monitors and other display devices, speakers, printers, network interface cards, modems, lenses, CCDs and other image capture devices, and the like.

Display devices include any type of device capable of displaying information to one or more users of a computing device in communication with the AIPAS 200. Examples of display devices include a monitor, display terminal, video projection device, and the like. A monitor and other types of display devices may also be connected to a system bus 134 via an interface 149, such as a video interface. A graphics interface may also be connected to a system bus. One or more graphics processing units (GPUs) may communicate with a graphics interface. In this regard, GPUs generally include on-chip memory storage, such as register storage and GPUs communicate with a video memory. GPUs, however, are but one example of a co-processor and thus a variety of co-processing devices may be included in a computer. In addition to a monitor, computers may also include other peripheral output devices such as speakers and printer, which may be connected through an output peripheral interface.

A bus 134 allows processor(s) 120, memory device(s) 122, interface(s) 149, mass/local storage device(s) 128, and I/O device(s) to communicate with one another, as well as other devices and components coupled to the bus. Bus represents one or more of several types of bus structures including a memory bus and memory controller, a peripheral bus, a system bus, and a local bus using any variety of bus architectures. By way of example and not limitation, these may include PCI bus, IEEE 1394 bus, USB bus, ISA bus, MCA bus, EISA bus, and VESA local bus.

One of ordinary skill in the art can appreciate that a computer or other client device can be deployed as part of a computer network 132. In this regard, the present invention pertains to any computer system having any number of memory and storage units, and any number of applications and processes occurring across any number of storage units and volumes. The present invention may apply to an environment with server computers and client computers deployed in a network environment, having one or more of remote and local storage. The present invention may also apply to a standalone computing device, having programming language functionality, interpretation, and execution capabilities.

Interface(s) 149 include various interfaces that allow any computing devices to interact with other systems, devices, and computing environments. Example interface(s) include any number of different network interfaces, such as interfaces to local area networks (LANs), wide area networks (WANs), wireless networks, and the Internet. Other interface(s) include user interface and peripheral device interface. An interface(s) may also include one or more user interface elements. An interface(s) may also include one or more peripheral interfaces such as interfaces for printers, pointing devices (mice, track pad, etc.), keyboards, and the like.

When used in a LAN networking environment, a computer is connected to the LAN through a network interface or adapter. When used in a WAN networking environment, the computer typically includes a modem or other means for establishing communications over the WAN, such as the Internet. A modem, which may be internal or external, may be connected to a system bus via a user input interface, or other appropriate mechanism. In a networked environment, program modules depicted relative to the computer, or portions thereof, may be stored in the remote memory storage device. By way of example and without limitation, remote application programs may reside on a memory device. It will be appreciated that network connections shown are exemplary and other means of establishing a communications link between the computers may be used.

Embodiments can also be implemented in cloud 156 computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

For purposes of illustration, programs and other executable program components are shown herein as discrete blocks, although it is understood that such programs and components may reside at various times in different storage components of a computing device and are executed by processor(s). Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions or code. These computer program instructions may be provided to a processor 120 of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

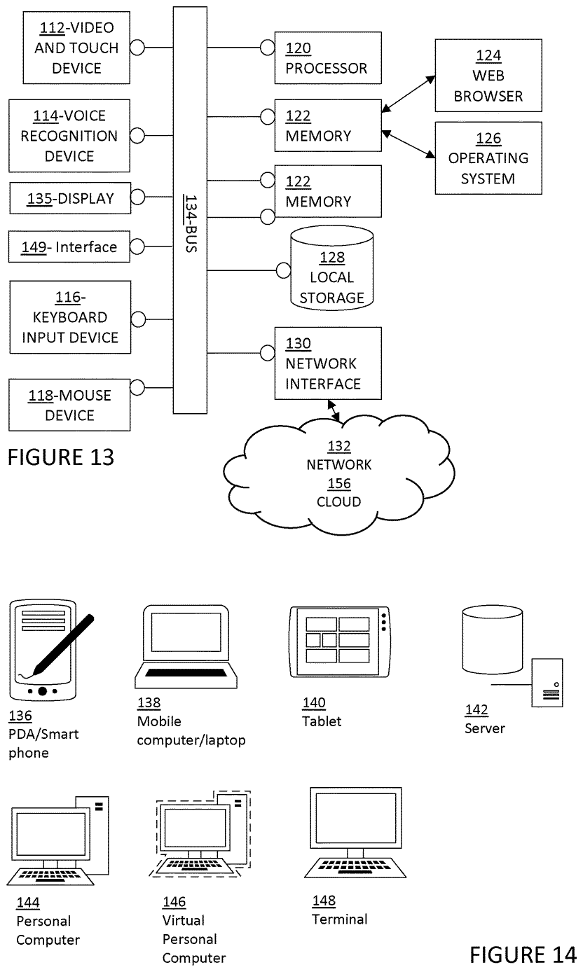

As depicted in FIG. 14, an AI processing architectural system can be utilized on a variety of forms of computing devices including but not limited to PDAs/smart phones 136, mobile computers/laptops 138, tablets 140, servers 142, personal computers 144, virtual personal computers 146, and other computer terminals 148.

It is noted that the terms “substantially” and “about” and “generally” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

The foregoing invention has been described in accordance with the relevant legal standards, thus the description is exemplary rather than limiting in nature. Variations and modifications to the disclosed embodiment may become apparent to those skilled in the art and fall within the scope of the invention.

1. A computer-implemented method for creating a searchable collection of industry standard architectural drawings comprising executing on a processor the steps of:
performing a layout segmentation process to detect all rooms and corresponding labels within an individual architectural drawing;
performing a drawing alignment process to implement a common grid system and aligning common drawing elements within the common the common grid system; and,
performing a metadata extraction process to create a searchable inventory of metatdata within the said architectural drawing collection.

2. The computer-implemented method for creating a searchable collection of industry standard architectural drawings of claim 1 wherein the step of performing a layout segmentation further comprises:
the step of executing a layout outline process to identify the floor plan outline of said architectural drawing collection.

3. The computer-implemented method for creating a searchable collection of industry standard architectural drawings of claim 2 wherein said layout outline process utilizes a segment anything model to generalize to unfamiliar objects and images.

4. The computer-implemented method for creating a searchable collection of industry standard architectural drawings of claim 1 wherein the step of performing a drawing alignment process further comprises:
executing a region segmentation process to identify meaningful areas on the architectural drawing.

5. The computer-implemented method for creating a searchable collection of industry standard architectural drawings of claim 4 wherein the step of executing a region segmentation process further comprises: utilizing a CubiCasa5k dataset.

6. The computer-implemented method for creating a searchable collection of industry standard architectural drawings of claim 4 wherein the step of executing a region segmentation process further comprises employing a pix2pix model.

7. The computer-implemented method for creating a searchable collection of industry standard architectural drawings of claim 1 wherein the step of performing a drawing alignment process further comprises:
executing a room number extraction process to extract all text from the architectural drawings using optical character recognition.

8. The computer-implemented method for creating a searchable collection of industry standard architectural drawings of claim 7 further comprising the step of employing an optical character recognition service such as AWS Textract or Google Vision to extract all text from the drawing images.

9. The computer-implemented method for creating a searchable collection of industry standard architectural drawings of claim 1 wherein the step of executing a drawing alignment process further comprises the step of identifying separate plans of the same location included within said searchable collection.

10. The computer-implemented method for creating a searchable collection of industry standard architectural drawings of claim 1 wherein the step of executing a drawing alignment process further comprises the step of executing a layout extraction pipeline that converts the said searchable collection of industry standard architectural drawings into digital, machine-readable components.

11. The computer-implemented method for creating a searchable collection of industry standard architectural drawings of claim 1 wherein the step of executing a drawing alignment process further comprises the step of identifying 3 common points on each of said searchable collection of industry standard architectural drawings.

12. The computer-implemented method for creating a searchable collection of industry standard architectural drawings of claim 1 wherein the step of executing a drawing alignment process further comprises the step of performing an affine transformation to ensure that all parallel lines in a drawing from the searchable collection remain parallel in an output image.

13. The computer-implemented method for creating a searchable collection of industry standard architectural drawings of claim 12 wherein the step of performing an affine transformation further comprises the step of determining a transformation matrix and converting coordinates.

14. The computer-implemented method for creating a searchable collection of industry standard architectural drawings of claim 1 wherein the step of executing metadata extraction further comprises the step of performing text extraction and cropping from a predetermined area of said architectural drawings to extract only relevant text.

15. The computer-implemented method for creating a searchable collection of industry standard architectural drawings of claim 14 wherein the step of performing text extraction and cropping further comprises cropping said architectural drawings to cover an area (0.8*max_x, 0, max_x, may_y).

16. The computer-implemented method for creating a searchable collection of industry standard architectural drawings of claim 1 wherein the step of executing metadata extraction further comprises the step of identifying metadata categories.

17. The computer-implemented method for creating a searchable collection of industry standard architectural drawings of claim 16 wherein the step of identifying metadata categories and wherein said metadata categories include sheet number, sheet title, date, last revision date, sheet type, sheet discipline, and floor number.

18. The computer-implemented method for creating a searchable collection of industry standard architectural drawings of claim 1 wherein the step of executing metadata extraction further comprises the step of integrating the results with a large language model to enhance accuracy.

19. The computer-implemented method for creating a searchable collection of industry standard architectural drawings of claim 18 wherein the step of integrating the results with a large language model further comprises the step of identifying metadata such as sheet number, sheet title, date, and revision date.

20. The computer-implemented method for creating a searchable collection of industry standard architectural drawings of claim 1 wherein the step of executing metadata extraction further comprises the step of results integration by merging outputs from both the rule-based approach and the large language model to achieve high accuracy.
